(19) United States
(12) Patent Application Publication
(10) Pub. No.: US 2004/0088550 A1
(43) Pub. Date: May 6, 2004

(54) Network access management

(76) Inventor: Rolf Maste, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/285,685

(22) Filed: Nov. 1, 2002

(51) Int. Cl. H04K 1/00

(52) U.S. Cl. 713/182

(57) ABSTRACT

An access management system for managing access of wireless terminals to a wireless communications network. The access management system comprises an access control unit for permitting use of the network by a wireless terminal; an access element arranged to provide access to the network for the wireless terminal if use is permitted by the access control unit; and a network means configured to receive and store information indicating that the wireless terminal is permitted to use the network. The network means is arranged to, if the access element is unable to provide the wireless terminal with access to the network, use the stored information to determine that the wireless terminal is permitted to use the network and, having so determined, provide an alternative access to the network for the wireless terminal.

### FIELD OF THE INVENTION

The present invention relates to an access management system for managing access of wireless terminals to a wireless communications network, and to a method of managing access of wireless terminals to a wireless communications network.

### BACKGROUND OF THE INVENTION

Wireless communications networks are known in the art and can be designed to cover geographical areas of varying sizes. One known type of wireless network is a Wireless Local Area Network (WLAN). Such a network is used in environments such as an office environment to provide a wireless communications service for a company. This may cover a relatively small area or it could cover a group of offices at different site locations. The idea of such a network is that the users can utilise network services like communicating with one another or accessing the internet without needing to use a fixed wire to the company's network. It is also known to provide a public wireless LAN, the idea of which is that travelling business users can remotely and wirelessly be connected to the company's network (corporate intranet) or the Internet. Such a network may be found in places that have a large number of business visitors such as airports, hotels and conference centres. Thus users of a LAN can be restricted to company employees or can also be visitors to the site or sites.

In a WLAN, access points (AP) provide the access to the WLAN for a wireless terminal. A wireless terminal for a WLAN network can take the form of, for example, a mobile telephone, a PDA, or a laptop computer. An access point provides to the Wireless device a point of entry into the network. When a user first wishes to connect to the network, that user is unauthenticated and must take part in an authentication procedure in order to use the network. The purpose of this procedure is to prevent use of the network by users who the company does not wish to use the network and possibly for charging. Once authenticated, a user can then possibly be authorised to use only some or all of the available LAN services. For example, certain groups of users may not be authorised to use certain network servers. Authentication and authorisation appear to the user as a single process.

A user is connected to one access point at a time, and this access point knows that the user has been authorised and authenticated to use the network If this access point, for some reason, goes down, the user needs to be connected to another access point, i.e. the user needs to be handed-over from the one access point to the other access point. This presents the problem that if the user is in the middle of an active connection and a delay occurs in the hand-over procedure, or the hand-over procedure occurs incorrectly, the result will be a loss of service for the user.

In known WLAN systems, when an access point to which a user is connected goes down, the wireless terminal (which is provided with a WLAN card for the purpose) Will try to hand over the user, together with any active connections, to another access point. However, this user is not recognised by this possible new access point as an authenticated and authorised user. In order to prevent a re-authentication procedure, two access points involved in a standard hand-over procedure (in which the first access point has not gone down) normally perform a hand-over procedure. This can occur without loss of service because the first access point informs the second access point that the user is authenticated and authorised. However, if the original access point is down, it cannot participate in this procedure. The result is that the new access point will not receive information from the original access point that that user is authenticated and authorised and consequently the new access point considers the user to be an unauthenticated user (that is trying to obtain its first contact) as there is no other way to find out if the user was authenticated before. This means that the user has to go through the authentication procedure again as the user's network connection is lost. In this situation, the user needs to re-authenticate and be re-authorised, which results in a loss of service for a period of time for the user and in inconvenience for the user to having to possibly collect credentials and enter authentication parameters again.

One known solution to this problem is to provide a duplicate access point for each access point. Thus information is stored in a duplicate access point that tells the duplicate access point that a user is authorised and authenticated so that upon receiving a request for a handover to the duplicate access point, it can provide the user with a connection to the network immediately. The disadvantage of this solution is that the duplicate access points sit idle until their counterpart working access points go down, which is inefficient and wasteful of resources and equipment.

It would be desirable to provide a more efficient solution to the problem of handover of a user from one access point to another without loss of service.

### SUMMARY OF THE INVENTION

According to a first aspect of the present invention, there is provided an access management system for managing access of wireless terminals to a wireless communications network, the access management system comprising: an access control unit for permitting use of the network by a wireless terminal; an access element arranged to provide access to the network for the wireless terminal if use is permitted by the access control unit; and a network means configured to receive and store information indicating that the wireless terminal is permitted to use the network, wherein the network means is arranged to, if the access element is unable to provide the wireless terminal with access to the network, use the stored information to determine that the wireless terminal is permitted to use the network and, having so determined, provide an alternative access to the network for the wireless terminal.

According to a second aspect of the present invention, there is provided a method of managing access of wireless terminals to a wireless communications network, the method comprising the steps of: deciding whether to permit a wireless terminal to use the network; if so permitted, providing access to the network for the wireless terminal via an access element; using a network means to receive and store information indicating that the wireless terminal is permitted to use the network, wherein the network means is arranged to, if the access element is unable to provide the wireless terminal with access to the network, use the stored information to determine that the wireless terminal is permitted to use the network and, having so determined, provide an alternative access to the network for the wireless terminal

According to a third aspect of the present invention, there is provided a network element for a wireless communications network which network provides an access to the network for a wireless terminal, the network element comprising: means configured to receive and store information indicating that a wireless terminal is permitted to use the network; means arranged to, in the event that the wireless terminal requests an alternative access to the network than its current access, use the stored information to determine that the wireless terminal is permitted to use the network; and means arranged to, after such determination, provide an alternative access to the network for the wireless terminal.

According to a fourth aspect of the present invention, there is provided A register of wireless terminals permitted to access a wireless communications network, the register comprising: means for receiving a query from a network element as to whether a wireless terminal is registered; means for, in response to such a query, determining whether the wireless terminal is registered; and means for, if it is determined that the wireless terminal is registered, responding to the query and sending a permission code for the wireless terminal to the network element.

### BRIEF DESCRIPTION OF THE DRAWINGS

Embodiments of the invention will now be described, by way of example only, with reference to the accompanying drawings in which:

FIG. 1 shows a plan view of part of a WLAN incorporating a number of access point cells.

FIG. 2 shows a schematic arrangement of elements of a WLAN including a mobile station requiring a connection to the network.

FIG. 3 is a schematic signalling diagram of the invention.

In the figures, like reference numerals indicate like parts

### DESCRIPTION OF THE PREFERRED EMBODIMENTS

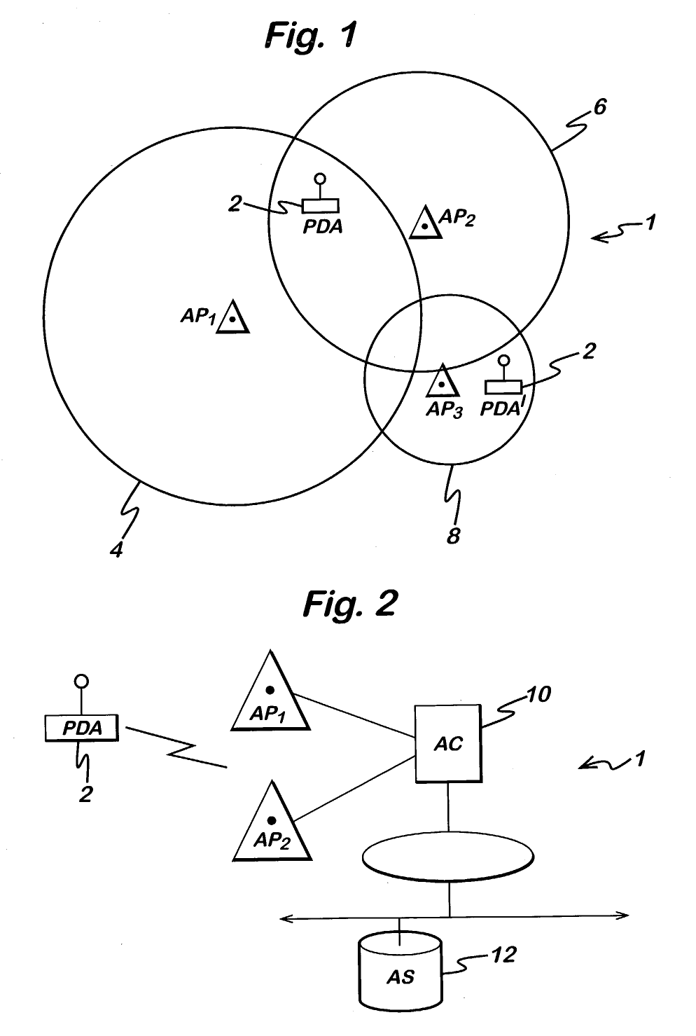

FIG. 1 shows part of a WLAN 1 and some of the system components in that part. The network 1 serves as a company intranet and also allows users access to the internet. It can be seen that the network 1 is divided into a number of cells, indicated by reference numerals 4, 6 and 8. The cells are shown to be approximately circular but in reality their intended area of coverage would vary in dependence on the layout of the site. Each cell 4, 6, 8 is served by an access point (AP), which are indicated as AP₁, AP₂ and AP₃ in the cells 4, 6, 8 respectively. An access point provides a connection to the network for users. In this embodiment the connection of a personal digital assistant (PDA) will be used as an example, but other entities such as laptops and WLAN capable cellular phones and pagers could be connected to the network 1 in a similar manner.

The size and shape of a cell 4, 6, 8 depends on the output power and sensitivity of the access point and terminals and the environment where the access point is placed in. Neighbouring access points influence the cell size as well. For example, if it is known that a large concentration of users will require connection to the network in a particular area of a company's site, one or more access points will be positioned so that each deals with a relatively small geographical area. If, on the other hand, use of entities requiring connection is likely to be rare, fewer access points can be used in a given geographical area. Thus in FIG. 1, it is expected that users will concentrate around AP₃, and hence the cell 8 is smaller than the cells 4, 6.

The possible cell area for any given access point is designed to overlap with one or more other cells to allow for flexibility as to which users are connected via which access points. This allows variation in access point load to be dealt with so as to avoid overloading and a resulting unacceptable drop in service quality. A full overlap is provided so that if a particular access point can not be used, there will always be another access point that can be used from any given location.

FIG. 1 shows two PDAs 2, PDA and PDA′. The PDA is situated in both the cells 4 and 6 and hence could be connected to the network 1 via either of the access points AP₁ or AP₂. The PDA′ is only situated in the cell 8 so would most appropriately be attached to the access point AP₃. However, it is not far from the edge of the cell 6 so could use the AP₂ if necessary and capacity allocations permits that.

Turning now to FIG. 2, for convenience only the PDA 2 and the AP₁ and AP₂ are shown. The two access points are shown to be connected to an access controller (AC) 10. The AC 10 acts as a gateway between the Internet and the wireless stations which are attached to a wireless LAN, and it thus provides a connection across the network 1 for all the access points that it serves. The AC 10 is also responsible for deciding and informing the access points whether users are allowed to use the network 1. Through the network 1 the AC 10 has access to an authentication server (AS) 12 that stores details of all users that are authenticated and authorised to use the network. The AS 12 may be used in conjunction with other registers that keep track of company employees and visitors and other information, but these details are not germane to the invention. Furthermore, the AC 10 could use means other than an AS to determine whether users should be allowed to use the network 1.

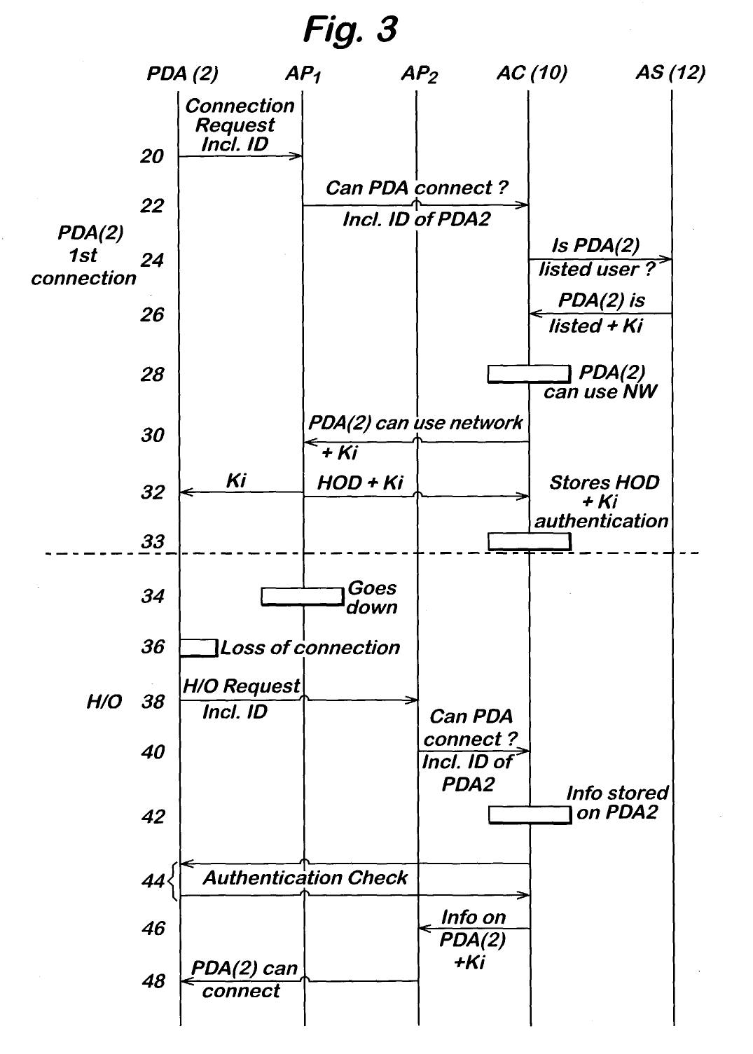

We will start from the situation of the PDA 2 wishing to connect to the network 1. As can be seen in FIG. 1, the PDA 2 is in the cells 4, 6 of both AP₁ and AP₂. Let us assume that the PDA 2 attempts to connect to the network 1 through the AP₁. The signal sequence is numbered in FIG. 3. The signals are divided into two sections, the first section being “PDA 2 1^{st} connection”. The signals of this first section can be explained as follows:

20 The PDA 2 sends a connection request signal to the AP₁, the signal including information identifying the PDA 2.

22 The AP₁ receives this signal and sends a signal to the AC 10 informing the AC 10 of the identifying information of the PDA 2 and asking whether the PDA 2 is allowed to be connected to the network 1.

24 The AC 10 sends a signal to the AS 12 asking whether the PDA 2 is a listed (or registered) user.

26 In response to this query, the AS 12 determines whether the PDA 2 is a listed user and returns the answer including a master encryption key Ki.

28 The AC 10 can then decide whether or not to allow the PDA 2 to use the network. For example, if the PDA 2 were not listed, this decision might depend on current network capacity. In this case, the PDA 2 is a listed user and the AC 10 decides for this reason to allow the PDA 2 to connect to the network 1.

30 The AC 10 sends a signal to the AP₁ informing it of this decision and the AP₁ then provides the PDA 2 with a connection. The AC 10 may also inform the PDA 2 which network services the user is authorised to use. For example the user may not be allowed access to certain files or services within the network 1. The signal passes on the master encryption key Ki.

32 The master encryption key is sent to the PDA 2 by the AP₁. Furthermore, the AP₁ sends the master encryption key Ki to the AC 10, together with hand-over data (HOD). This data includes information such as information identifying the PDA 2, information indicating that the PDA 2 is allowed to use the network 1, as well as possibly information indicating which network services the PDA 2 is authorised to use.

33 The AC 10 stores the HOD and the master encryption key sent to it by the AP₁. Indeed, each time any user is authenticated and authorised to use the WLAN 1, sufficient details are stored in the AC 10. The AC 10 is a good place to store this user information as the AC 10 is the central network element of either the whole of the network 1 or at least a part of it, depending on the size of the network 1. The AC 10 has the capability to store large amounts of data, and is therefore very convenient for this task.

The AC (10) performs the further step of calculating an authentication number for the PDA 2 using the key Ki and a random number. The authentication number and the random number are also stored by the AC 10.

Since the AP₁ is connected to the AC 10, the PDA 2 user's connections can be established across the network 1, for example to pick up e-mail, as is known in the art. However, if the AP₁ goes down, it immediately is no longer able to provide any connectivity between the network and the PDA 2, and the PDA 2 must find an alternative access point into the network. The signals when this situation occurs are shown in the second section of FIG. 3 “H/O” and can be explained as follows:

34 The AP₁ goes down and is therefore no longer able to provide the PDA 2 with access to the network 1 (36).

38 The PDA 2 sends a handover request signal to the next nearest access point, which in this case is the AP₂. The handover request includes information identifying the PDA 2.

In a prior art system, the AP₂ would not recognise the PDA 2 as one of the users for which it provides a connection because since the AP₁ is down, it can not inform the AP₂ that the user is authenticated and authorised. The PDA 2 therefore needs to go through the above described authorisation and authentication procedure, via the AC 10 and the AS 12. This would result in loss of service for a period of time for the user of the PDA 2, which would be most inconvenient if the user were in the middle of an active connection.

By contrast, in this embodiment the following signalling steps occur:

40 The AP₂ passes on the handover request including the information identifying the PDA 2, to the AC 10.

42 The AC 10 ascertains from its own records that the PDA 2 is an authenticated user.

44 The AC 10 then performs an authentication check on the PDA 2 by sending the stored random number to the PDA 2 (via the AP₂). The PDA 2 uses the random number and the key Ki to calculate the authentication number, and sends the authentication number back to the AC 10 (via the AP₂). In this case the authentication number is correct. If the PDA 2 was not in fact an authorised user but was trying to access the network using the user identification of the PDA 2, it would not have the correct key Ki and would therefore not be able to calculate the authentication number correctly. Consequently access would be denied.

46 Since the authentication number is correct in this case, the AC 10 immediately informs the AP₂ of this and passes the master encryption key Ki to the AP₂, and at the same time possibly informs the AP₂ which network services the PDA 2 is authorised to use.

48 Thus the user is re-authenticated and the AP₂ is able to provide a connection to the network for the PDA 2 without the user having to re-authenticate himself as described above with reference to the first section of FIG. 3 (PDA 2 1^{st} connection). Once the user has been re-authenticated by reference to the AC 10, his client, the PDA 2 is informed by the AP₂ that the user has been accepted and he can continue with the applications where he was before the AP₁ went down.

The storing of the details of the PDA 2 could be done by network elements other than the AC 10, For example, it could be done by a server that takes on this task or one or more other access points such as AP₂ and AP₃. In the latter implementation, a number of users could have their details stored in two or more access points so that those access points would be ready to allow those users access to the network 1 without incurring loss of service. This implementation may require some extra access points beyond the basic minimum number required in prior art systems, but these access points can be positioned in an efficient manner so that less than double the number of access points (as in the duplicate access point prior art system) is required, or positioned in any way that all access points contribute to the capacity of the WLAN.

The use of the encryption key is not essential for operation of the invention, but use of such a key or other security data provides an extra layer of security against unauthorised use of the network. An encryption key is not the only way of providing security, other forms of Security Association Data (SAD) could be used.

Thus the embodiments provide the advantage over some known systems that there is no need for access point duplication because only network elements that have other functions are used to implement the invention i.e. they provide capacity. Consequently a break down of one access point will not mean a service breakdown for one or more users, but rather a decrease of maximum capacity. In practice, most of the time, network capacity is not fully used and hence a breakdown of an access point will not be perceived by the user.

The method of operation of the embodiments described above could be applied to other types of network than WLANs, using equivalent network elements. Furthermore, other network elements than the specific ones mentioned could be used to implement the embodiments in a WLAN.

What is claimed is:

1. An access management system for managing access of wireless terminals to a wireless communications network, the access management system comprising:
an access control unit for permitting use of the network by a wireless terminal;
an access element arranged to provide access to the network for the wireless terminal if use is permitted by the access control unit; and
a network means configured to receive and store information indicating that the wireless terminal is permitted to use the network,
wherein the network means is arranged to, if the access element is unable to provide the wireless terminal with access to the network, use the stored information to determine that the wireless terminal is permitted to use the network and, having so determined, provide an alternative access to the network for the wireless terminal.

2. An access management system according to claim 1, wherein the access control unit uses information identifying the wireless terminal to permit use of the network by the wireless terminal.

3. An access management system according to claim 1, wherein the access element is further arranged to provide the access control unit with information identifying the wireless terminal.

4. An access management system according to claim 1, wherein the access element is further arranged to receive notification from the access control unit that the wireless terminal is permitted to use the network, and, after receiving the said notification, to provide said alternative access to the network for the wireless terminal.

5. An access management system according to claim 1, wherein the network means is further configured to receive and store information identifying the wireless terminal.

6. An access management system according to claim 1, wherein the network means is arranged to additionally perform its other network activity.

7. An access management system according to claim 1, wherein the network means is arranged to provide the said alternative access to the network for the wireless terminal without the access control unit re-permitting use of the network by the wireless terminal.

8. An access management system according to claim 1, wherein the access element is further arranged to receive a request for access to the network from a wireless terminal, the said request including information identifying the wireless terminal.

9. An access management system according to claim 1, wherein the network means is further arranged to determine whether the wireless terminal is in an active connection with the network, and if the wireless terminal is in an active connection with the network, to provide said alternative access to the network for the wireless terminal without disrupting the active connection.

10. An access management system according to claim 1, wherein the network comprises a register of wireless terminals and the access control unit is arranged to access the register to determine if the wireless terminal is registered in order to permit use of the network by the wireless terminal.

11. An access management system according to claim 10, wherein the register is configured to send security data for the wireless terminal to the access control unit.

12. An access management system according to claim 11, wherein the access control unit is arranged to send the security data to the access element.

13. An access management system according to claim 12, wherein the access element is arranged to send the security data to the wireless terminal.

14. An access management system according to claim 11, wherein the access control unit uses the security data to permit use of the network by the wireless terminal.

15. An access management system according to claim 11, wherein the network means is arranged to use the security data to determine that the wireless terminal is permitted to use the network.

16. An access management system according to claim 11, wherein the security data comprises Security Association Data.

17. An access management system according to claim 11, wherein the security data comprises an encryption key.

18. An access management system according to claim 1, wherein the network is a local area network.

19. An access management system according to claim 18, wherein the access element is an access point (AP) to the network.

20. An access management system according to claim 1, wherein the network means is a second access element.

21. An access management system according to claim 1, wherein the network means and the access control unit are a single unit, and the access control unit provides said alternative access to the network for the wireless terminal via a second access element.

22. An access management system according to claim 1, comprising multiple network elements, each configured to receive and store information identifying one or more wireless terminals and information indicating that those wireless terminals are allowed to use the network, and to provide said alternative access to the network for the said one or more wireless terminals if the access element is unable to provide those wireless terminals with access to the network.

23. A method of managing access of wireless terminals to a wireless communications network, the method comprising the steps of deciding whether to permit a wireless terminal to use the network;
if so permitted, providing access to the network for the wireless terminal via an access element;
using a network means to receive and store information indicating that the wireless terminal is permitted to use the network,
wherein the network means is arranged to, if the access element is unable to provide the wireless terminal with access to the network, use the stored information to determine that the wireless terminal is permitted to use the network and, having so determined, provide an alternative access to the network for the wireless terminal.

24. A network element for a wireless communications network which network provides an access to the network for a wireless terminal, the network element comprising:
means configured to receive and store information indicating that a wireless terminal is permitted to use the network,
means arranged to, in the event that the wireless terminal requests an alternative access to the network than its current access, use the stored information to determine that the wireless terminal is permitted to use the network; and
means arranged to, after such determination, provide an alternative access to the network for the wireless terminal.

25. A network element according to claim 24, arranged to use security data to determine that the wireless terminal is permitted to use the network.

26. A network element according to claim 25, arranged to receive the security data from a register of the network.

27. A network element according to claim 25, wherein the security data comprises Security Association Data.

28. A network element according to claim 25, wherein the security data comprises an encryption key.

29. A network element according to claim 28, arranged to calculate an authentication number for the wireless terminal using the encryption key.

30. A network element according to claim 29, arranged to use the encryption key and the authentication number to determine that the wireless terminal is permitted to use the network.

31. A network element according to claim 24, further configured to receive and store information identifying the wireless terminal.

32. A network element according to claim 24, further arranged to perform other network activity.

33. A network element according to claim 24, arranged to provide the said alternative access to the network for the wireless terminal without obtaining permission from any other part of the network for the wireless terminal to access the network.

34. A network element according to claim 24, wherein the network means is further arranged to determine whether the wireless terminal is in an active connection with the network, and if the wireless terminal is in an active connection with the network, to provide said alternative access to the network for the wireless terminal without disrupting the active connection.

35. A network element according to claim 24, which is an access controller.

36. A network element according to claim 24, which is an access point.

37. A register of wireless terminals permitted to access a wireless communications network, the register comprising:
means for receiving a query from a network element as to whether a wireless terminal is registered;
means for, in response to such a query, determining whether the wireless terminal is registered;
means for, if it is determined that the wireless terminal is registered, responding to the query and sending security data for the wireless terminal to the network element.

38. A register according to claim 37, wherein the security data comprises Security Access Data 39. A register according to claim 37, wherein the security data comprises an encryption key.
